(19) United States
(12) Patent Application Publication
(10) Pub. No.: US 2016/0330258 A1
(43) Pub. Date: Nov. 10, 2016

(54) BROADCASTS AMONG ELECTRONIC DEVICES OF REGISTERED USERS VIA INTERNET PROTOCOL

(71) Applicant: Charanjit Singh Sandhu, Brampton (CA)

(72) Inventor: Charanjit Singh Sandhu, Brampton (CA)

(21) Appl. No.: 14/922,924

(22) Filed: Oct. 26, 2015

Related U.S. Application Data
(60) Provisional application No. 62/158,747, filed on May 8, 2015.

(51) Int. Cl. H04L 29/06; H04L 29/08; H04L 12/58; H04L 29/12

(52) U.S. Cl. CPC H04L 65/4076; H04L 61/1541; H04L 65/1069; H04L 67/16; H04L 51/046; H04L 61/605

(57) ABSTRACT

A server-based Internet service, with client-side applications, is described that enables users to communicate between electronic devices such as smartphones, tablets and personal computers by broadcasting live video, voice and/or text via an internet protocol (IP) address. Broadcasting can be done in both private and public formats. Private broadcasts can be made ‘one-on-one’ between two registered users or among a group of private contacts. Public broadcasts can be accessed by any registered users and can also be transmitted to registered ‘Followers’. In addition to designating ‘Followers,’ users can also designate types of content that they wish to follow, e.g. video, voice and/or text. Broadcasts are stored on service provider servers where they can be searched by title, category, proximity or by description, and accessed at a later time. Broadcasts may also be designated as ‘Favorites’ for easier access in the future. Once accessed, broadcasts can be organized alphabetically or chronologically.

### CROSS-REFERENCE TO RELATED APPLICATIONS

The present application claims priority and benefit from U.S. Provisional Application No. 62/158,747, filed May 8, 2015, entitled “BROADCASTS AMONG ELECTRONIC DEVICES OF REGISTERED USERS VIA INTERNET PROTOCOL,” the entire content of which is incorporated herein by reference for all purposes.

### BACKGROUND OF THE INVENTION

The present subject matter relates generally to broadcast services (e.g. video, audio, text, etc.) that are provided among a group of registered users in various modes using Internet, or other network, protocol.

Various video capture and distribution methods over the Internet are known, such as video conferencing, uploading and/or posting videos to websites, etc. However, known methods are generally limited in their ability to rapidly share and/or access broadcasts among select individuals or a broader community, without pre-coordination and/or with minimal user interaction.

Accordingly, there exist ongoing needs to provide improved means for capturing and sharing broadcasts among various users.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

According to first aspects of the invention, a platform (e.g. server-based Internet service with client-side applications) is provided that enables users to communicate between electronic devices such as smartphones, tablets and personal computers by broadcasting live video, voice and/or text via an internet protocol (IP) address. Broadcasting can be done in both private and public formats. Private broadcasts can be made ‘one-on-one’ between two registered users or among a group of private contacts. Public broadcasts can be accessed by any registered users and can also be transmitted to registered ‘Followers’. In addition to designating ‘Followers,’ users can also designate types of content that they wish to follow, e.g. video, voice and/or text. Broadcasts are stored on service provider servers where they can be searched by title, category, proximity or by description, and accessed at a later time. Broadcasts may also be designated as ‘Favorites’ for easier access in the future. Once accessed, broadcasts can be organized alphabetically or chronologically.

In some examples, broadcasting different types of content can be done simultaneously to the same or different audiences, e.g. using different, or combined, windows of an application. For example, users may have a portion of the application window displaying an instant messaging discussion, while viewing a live broadcast with other viewers of the same broadcast in another portion of the application window. In some examples, users may be able to send invitations to other users to specific types of content streaming. For example, a user that is viewing a video stream from another user may invite the broadcasting user to join a chat session, e.g. via a link that is displayed in the chat window or video broadcast window, while viewing the broadcast. By way of further examples, a user may engage in video conferencing or a voice call while also instant messaging or broadcasting video (to the same or different audience). Still pictures can also be taken, or captured from a video stream, while broadcasting, texting or talking

In some examples, public broadcasts become the property of the service provider and cannot be edited or deleted, but private broadcasts can be edited or deleted. Private broadcasts can also be rebroadcast publicly in the future. In some examples, the platform also allows users to create an email address associated with the service provider that is simple to use, allows attachments and is compatible with other email platforms. In addition to email, systems and methods described herein may also allow users to send content such as pictures and documents as attachments within an instant messaging or other feature. The client-side application may be made available in multiple languages and can be downloaded, for example, in Android, iOS and/or Microsoft Windows format.

According to further aspects of the invention, the client-side application may include a synchronization routine whereby contacts on the user device are compared to registered users of the service, e.g. by searching the user accounts on the service provider servers based on unique device identifiers such as unique phone numbers. The client-side application may then present a list of registered users that correspond to contacts stored on the user device, making it easy for users to make positive contact with existing contacts that are registered users of the service, without opening users to myriad contact requests from unknown individuals.

In embodiments, a registration protocol may be provided that requires users to provide a bona fide phone number or other unique device identifier in order to register with the service.

In embodiments, client-side applications may be configured to allow users to launch broadcasts to selected contacts, to the community of registered users and/or followers, within chat sessions between registered users, etc., providing substantial flexibility and ease of use. The platform may also allow the creator of the broadcast to assign various parameters to the broadcast, such as public/private, title, genre, location, names, etc.

According to further aspects of the invention, the service provider server may be configured to alert registered users about broadcasts directed to them, or otherwise of interest, using various means, such as communicating an alert via the client-side application indicating that a broadcast is currently available for registered user, and/or by instant messaging, email, or other account-based communications. Embodiments may also include functions allowing users to turn notifications on or off, e.g. for another user, content type, category, etc. Accordingly, users may be allowed to customize their alerts, e.g. to only receive notifications for the content they wish to follow for a particular broadcaster.

In some examples, client-side applications may include features that allow a user to disable all, or some, notifications, e.g. via one or more icons, when broadcasting and/or viewing streaming content. The notifications that are disabled may include, for examples, incoming phone call, e-mail, appointment, or any other visual and/or audio, notifications presented on the user device. In some examples, the notification disable function may allow the user to select certain applications and/or types of notifications that are allowed, such as specifying “disable text message visual notification; allow text message vibration notification,” etc. Applications may also be configured to change settings, such as sending a call immediately to voicemail, when an event notification would otherwise be generated. In some examples, a log of blocked notifications may be generated, and presented to the user after the broadcast is completed.

In some examples, broadcast screens may also include a ‘pause’ icon that allows the user to pause a stream while broadcasting, e.g. video, audio, etc. Streaming server(s) may be configured, for example, to present a static image to broadcast viewers while the broadcast is paused, and/or to pause storage of the broadcast file on the server. The server(s) may also be configured to notify viewers when broadcasting restarts, e.g. using similar techniques to initial broadcast notification(s).

In embodiments, the platform may include various mechanisms for limiting abuse of the broadcast functionality by certain users or according to certain situations. These may include, for example, limiting an amount of time allowed for individual broadcasts, deleting older content when a user's storage capacity is reached, adding additional charges for exceeding storage limits, throttling broadcasts during peak times, etc. In some examples, systems and methods described herein may also include functionality that adds advertisements, such as commercials, before or after a streaming session, or adds banner advertisements or the like to public streaming sessions. In some embodiments, the streaming service provider may also limit users from broadcasting content from which they receive revenue, e.g. by scanning streaming data for embedded advertisements, etc. Thus, the service provider can be equipped with means for reserving the rights to revenue streams generated by videos or advertisements on videos. In some examples, streaming sessions may be monitored for content that is prohibited by the service provider's terms of use, or the like, and accounts may be automatically suspended based at least in part on such scans.

According to further aspects of the invention, a system for selectively providing streaming services in a network environment may include one or more of a database including a plurality of registered user accounts for a first service provider, each user account having a unique identifier assigned to a user of the account by a second service provider, and a network server configured to establish a first network connection with a first user device associated with a first user account; receive instructions to begin a first streaming session; send a notification of the first streaming session to at least one other user account; receive streaming data of the first streaming session from the first user device; store at least part of the streaming data in association with the first user account; receive a confirmation from the at least one other user indicating acceptance of the streaming session; establish a second network connection with the at least one other user based on said confirmation; and/or deliver at least part of the streamed data to the at least one other user via the second network connection. In some examples, the instructions to begin the first streaming session may include a streaming mode selection that identifies the first streaming session as a public broadcast or a private broadcast. In some examples, the server may be further configured to make public broadcast available to all of the registered user accounts, and/or to make private broadcasts available to a select subset of the registered user accounts.

In embodiments, the unique identifier may be a phone number, and the server may be further configured to automatically determine the validity of the phone number as part of registering a user account. In some examples, the first service provider may be a video streaming service, the second service provider a phone company, and the unique identifier a phone number.

In embodiments, the server may be further configured to, for example, receive contact information from the first user device; compare the contact information to the unique identifiers of at least some of the user accounts stored in the database; and/or generate computer instructions that allow the first user device to show registered user accounts having unique identifiers that match the contact information.

In embodiments, sending the notification of the streaming session to at least one other user may include sending notifications to contacts associated with the first user account and/or followers associated with the first user account.

In embodiments, the server may be further configured to receive contact selection information from the first user device, the contact selection information identifying registered user accounts that a private broadcast is to be shared with.

In embodiments, the server may be further configured to receive identifying information from the first user device, the identifying information associated with the first streaming session and including a time stamp, a location, a title, a category, and/or a streaming mode.

In embodiments, at least some of the identifying information may be received from the first user device after receiving at least some of the streaming data of the first streaming session from the first user device. For example, the user can provide identifying information during the streaming session and/or after completion of the streaming session. In some examples, an application on the personal device may be configured to prompt the user for identifying information upon completion of a ‘Quick Clip’ or other streaming session in which certain information was not provided before streaming was initiated. In some examples, a ‘Quick Clip’ icon can be added to the main user interface screen, or other application, in order to allow immediate broadcast capability.

In embodiments, the server may be configured to support chat session between registered users, and to begin the first streaming session between registered users participating in a chat session.

According to further aspects of the invention, a personal computing device configured to provide streaming services may include one or more of a network communication transceiver; a camera; a processor; and/or a memory including computer-executable instructions that configure the processor to exchange registration information with a first service provider in order to obtain a registered user account. In some examples, the registration information may include a unique identifier assigned to the personal computing device by a second service provider. Computer-executable instructions may also be provided that configure the processor to scan at least part of the memory for contact information; extract unique identifiers from contact information found by the scan; send indicia of the unique identifiers to the first service provider; receive conformation from the first service provider that one or more contacts associated with the unique identifiers are registered users of the first service provider; and set the one or more contacts associated with the unique identifiers as streaming contacts.

In embodiments, computer-executable instructions may also be provided that configure the processor to establish a first network connection with a streaming server associated with the first service provider; send instructions to the streaming server to begin a first streaming session; capture image data via the camera; and/or send streaming data of the first streaming session to the streaming server, the streaming data including the captured image data. In embodiments, the instructions to begin the first streaming session may include a streaming mode selection that identifies the first streaming session as a public broadcast or a private broadcast. In embodiments, instructions to begin private broadcasts may include identification of the one or more contacts to whom the private broadcast is made available.

In embodiments, the device may include at least two cameras that can be alternated for different streaming sessions and/or alternated between while sending the streaming data.

Embodiments may also support capturing videos from the front or back camera in ‘Portrait’ or ‘Landscape’ modes. In some examples, the camera may be rotated while broadcasting without interruption.

According to further aspects of the invention, a streaming application may be provided including computer instructions configured to exchange information between hardware onboard a personal computing device and a remote server associated with a first service provider, and to present a graphical user interface on a display of the personal computing device. The graphical user interface may include a plurality of different interactive screens including one or more of a registration interface configured to receive commands for registering the personal computing device with the first service provider using a unique identifier assigned to the personal computing device by a second service provider; a contact synchronization interface configured to identify potential contacts for the streaming application based at least in part on scanning for contact information, extracting unique identifiers from contact information found by the scan, sending indicia of the unique identifiers to the first service provider, and/or receiving conformation from the first service provider that one or more contacts associated with the unique identifiers are registered users of the first service provider; a streaming initiation interface configured to allow a user of the personal computing device to initiate a first streaming session from among a plurality of streaming modes, the plurality of streaming modes including at least a private mode and a public mode; a private session interface, initiated by selection of the private mode and configured to allow a user of the personal computing device to identify certain registered users of the first service provider that the first streaming session will be shared with; and/or a public session interface, initiated by selection of the public mode and configured to share the first streaming session with at least some registered users of the first service provider that are not specifically authorized by the user.

In embodiments, the public mode may share the first streaming session with all registered users of the first service provider. In embodiments, a chat interface may be configured to present chat sessions between registered users of the first service provider, and to begin the first streaming session between registered users while participating in a chat session.

Embodiments may further include instructions for establishing a first network connection with a streaming server associated with the first service provider; sending instructions to the streaming server to begin the first streaming session; capturing image data via a camera; and/or sending streaming data of the first streaming session to the streaming server, the streaming data including the captured image data.

In some examples, two or more broadcasts can be coordinated into a single broadcast, e.g. that shows in a single screen or a view that rotates broadcasters.

According to further aspects of the invention, computer-implemented methods and/or computer-readable storage medium may be provided including executable code for configuring a computer processor to perform any of the processes described herein.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

For a fuller understanding of the nature and advantages of the present invention, reference should be made to the ensuing detailed description and accompanying drawings.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 is a schematic diagram representing a network environment in which broadcasts are shared among various user devices via a network server.

FIGS. 2-3 show registration interface screen shots of a client-side application whereby a user can register with a streaming service, according to certain embodiments of the invention.

FIG. 4 shows a screen shot of a pull-down menu for a client-side application whereby a user can select various functions included in and/or supported by a streaming service, according to certain embodiments of the invention.

FIGS. 5-6 show screen shots of a contact synchronization procedure for a client-side application, according to certain embodiments of the invention.

FIG. 7 shows a screen shot of a chat launch interface for a client-side application, including identified contacts, according to certain embodiments of the invention.

FIG. 8 shows a screen shot of a video broadcast dashboard interface for a client-side application, including identified contacts, according to certain embodiments of the invention.

FIGS. 9-10 show screen shots of chat interfaces for a client-side application, including various streaming launch icons, according to certain embodiments of the invention.

FIG. 11 shows a screen shot of a private broadcast interface for a client-side application, including selectable contacts to share the broadcast with, according to certain embodiments of the invention.

FIG. 12 shows a screen shot of a camera select interface for a client-side application, which can be used in various streaming modes, according to certain embodiments of the invention.

FIGS. 13-14 show screen shots of a streaming mode selection interface for a client-side application, which can be used to select between various streaming modes and/or provide identifying information for streaming sessions, according to certain embodiments of the invention.

FIG. 15 shows a screen shot of a video streaming interface for a client-side application, according to certain embodiments of the invention.

FIG. 16 shows a screen shot of a follower interface for a client-side application, including registered users whose streams are being followed by the application user, according to certain embodiments of the invention.

FIG. 17 shows a library interface for a client-side application, including saved video streams that were created by the application user, according to certain embodiments of the invention.

FIG. 18 shows a library interface for a client-side application, including all video streams that are accessible by the application user, according to certain embodiments of the invention.

FIG. 19 shows a library interface for a client-side application, including all video streams by registered who the application user is following, according to certain embodiments of the invention.

FIG. 20 is a schematic diagram showing synchronization relationships between a first device, a streaming server and second device, according to certain embodiments of the invention.

FIG. 21 is a schematic diagram showing streaming relationships between a first device, a streaming server and second device, according to certain embodiments of the invention.

FIG. 22 is a schematic diagram depicting aspects of a public broadcast between a first device, a streaming server and various other devices, according to certain embodiments of the invention.

FIG. 23 is a schematic diagram depicting aspects of a private broadcast between a first device, a streaming server and various specified contacts, according to certain embodiments of the invention.

FIG. 24 is a schematic diagram depicting aspects of a broadcast that transitions between portrait and landscape orientation, according to certain embodiments of the invention.

FIG. 25 is a schematic diagram depicting aspects of a ‘Quick Clip’ broadcast between a first device, a streaming server and various contacts and followers, according to certain embodiments of the invention.

FIG. 26 is a schematic diagram depicting aspects of a coordinated broadcast, according to certain embodiments of the invention.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details.

Furthermore, well-known features may be omitted or simplified in order not to obscure the embodiment being described.

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise. Thus, for example, a reference to “a server” is a reference to one or more servers and equivalents thereof known to those skilled in the art.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

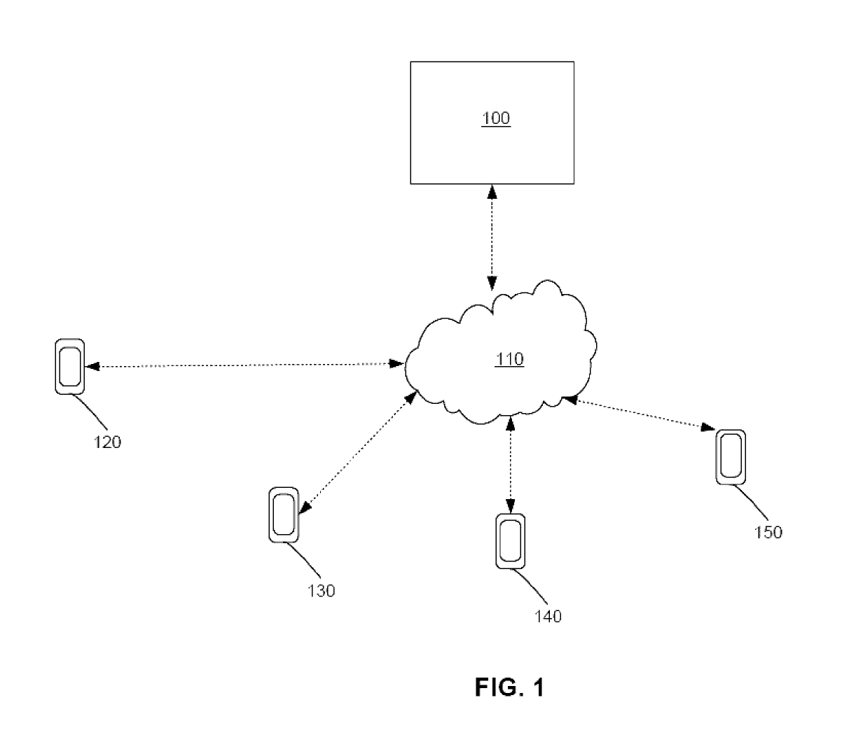

FIG. 1 is a schematic depiction of a network environment in which broadcasts are shared among various user devices via a network server, according to aspects of the invention. As shown in FIG. 1, a service provider server 100 may communicate with various user devices via network 110, such as the Internet. User devices 120-150 may be registered with the service provider server 100, preferably via phone number or other bona fide unique identifier.

As described further herein, any of user devices 120-150 may be used to generate and/or consume broadcast information via the server 100. For example, a user of device 120 may initiate a public video broadcast whereby any of devices 130-150 may be able to access/consume the video broadcast. Alternatively, the user of device 120 may select one or more contacts associated with devices 130-150 to share a private broadcast with. Preferably, the broadcast is communicated to the server 100 and stored thereon. The broadcast can be distributed by the server to other user devices in substantially real time, and/or played at a later time upon request of an authorized device. As such, different users are provided maximum flexibility in being able to consume a ‘live’ broadcast, or go back and watch it later if that is better for their schedule, etc.

In some examples, the server 100 may push notifications to all or some of user devices 120-150 regarding broadcasts that are directed to, or accessible by, those devices. This may be accomplished in myriad ways, such as using application-specific protocols, text messaging, email, or any other communication means linked to the registered user device or other designated means. Preferably, notifications sent to the user device include embedded instructions that allow the receiving user to seamlessly launch the broadcast, e.g. by pressing a ‘Play’ button or any other similar icon.

The server 100 and user devices 120-150 may include memory and one or more processors that collectively execute instructions stored in the memory for performing functionality described herein.

The one or more processors of user devices 120-150 may operate an application that collects information and performs operations in accordance with the present disclosure. For example, the one or more processors may enable the user devices 120-150 to implement an application that determines various menus and presents the various menus to a user via a display, speaker, or other output of user devices 120-150 or other associated device (e.g. a home entertainment system in communication with one of the user devices). In some examples, the client applications may be configured to broadcast directly to a television or other device utilizing Bluetooth or another connection.

The memory may additionally store various information that allows for various determinations to be made for the presentation of dynamically determined menus in accordance with the various embodiments.

The present invention is well suited for use with a global computer communication network such as the Internet. However it can be appreciated that, as future technologies are created, various aspects of the invention may be practiced with these improved technologies. In addition, various wireless technologies provide a suitable communications medium for operating aspects of the present invention.

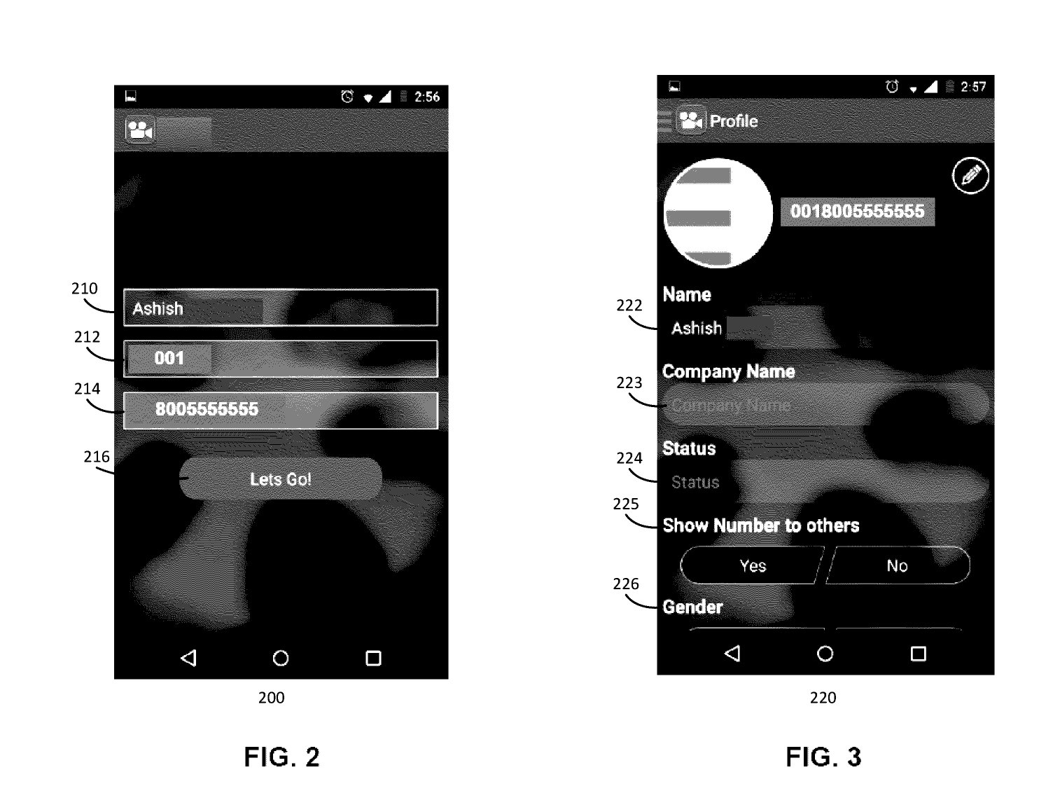

Turning to FIG. 2, users may begin by downloading the platform's application software on to their electronic/mobile device. The registrant may register on the platform via application screen 200 using their name in field 210 and a unique phone number 214 with country code 212, such as shown in FIG. 2. In some examples, the device they are using to register may be required to have a functioning Internet/WiFi connection. A phone number may be required for registration in order to ensure that all registrants are unique individual users. This also allows content creators to be accurately identified and credited. Lastly, requiring users to register using a unique phone number helps minimize fake and duplicate user accounts, and also encourages better quality of content and user friendliness. However, in order to protect the user's privacy, the phone number may not displayed publically and the user may retain the right to keep their phone number hidden. The information acquired via screen 200 may be transmitted to the service provider server, e.g. 100, in order to register a user profile. In some examples, the service provider server may be configured to automatically determine the validity of the phone number provided. In some examples, the client-side application may be able to do this independently, e.g. by comparing the number entered in 214 with device data, and/or by automatically acquiring the number in 214.

In some examples, the user may provide or be provided a unique email address. The user's email address can also remain hidden at the user's option for privacy and also to avoid receiving spam. In the case of an email address provided by the platform, that email address may be linked to the user's phone number and may only be accessible through the registrant's device. In the event that the user relinquishes their phone number, their platform email address may automatically be deleted. The user can be identified by a chosen user name and multiple users can be organized under a single company name. In some examples, the streaming server may also be configured to recognize users that log on to the system from devices other than the uniquely identified device(s) that are linked to their account. For example, a unique identifier such as email, phone number or a chosen log in and password may be used to access their account from a device other than their primary phone (e.g. another phone, desktop, tablet or other computing device).

Upon registering, users may then create a profile identifying themselves on the platform. This may include presenting an application screen 220 such as shown in FIG. 3, and communicating the information to the platform server. In the profile interface users can edit their name 222, company 223, status 224, gender 226, privacy or other preferences 225, email, other social media account information, or any other relevant fields that the platform allows. Users may also complete an ‘About’ section in which they can add whatever text they wish.

Phone numbers, or other unique identifiers, however, may be controlled such that they may not be edited, or may only be edited under certain circumstances, such as the user substituting another bona fide phone number. Users may also add a picture album and video, audio or text blogs to their profile. Images can be selected from their device gallery or can be taken by camera.

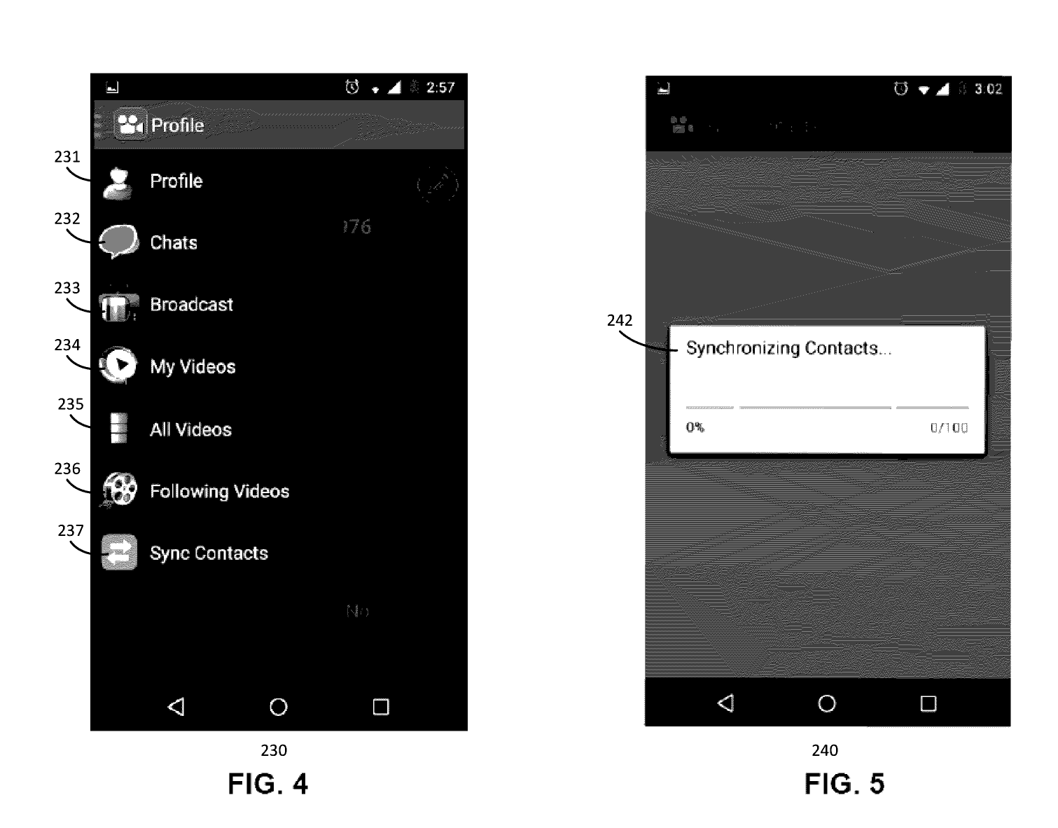

The client-side application may include a dashboard or a pulldown menu with various commands such as the screen 230 shown in FIG. 4. These may include, for example, commands for accessing/editing profile information 231, chat 232 and/or broadcast 233 launch buttons, a button 234 to access videos (or other broadcasts) created by that device, a button 235 to browse all broadcasts that the user has access to and/or button 236 for broadcasts that the user is ‘following,’ a synchronize contacts button 237, etc.

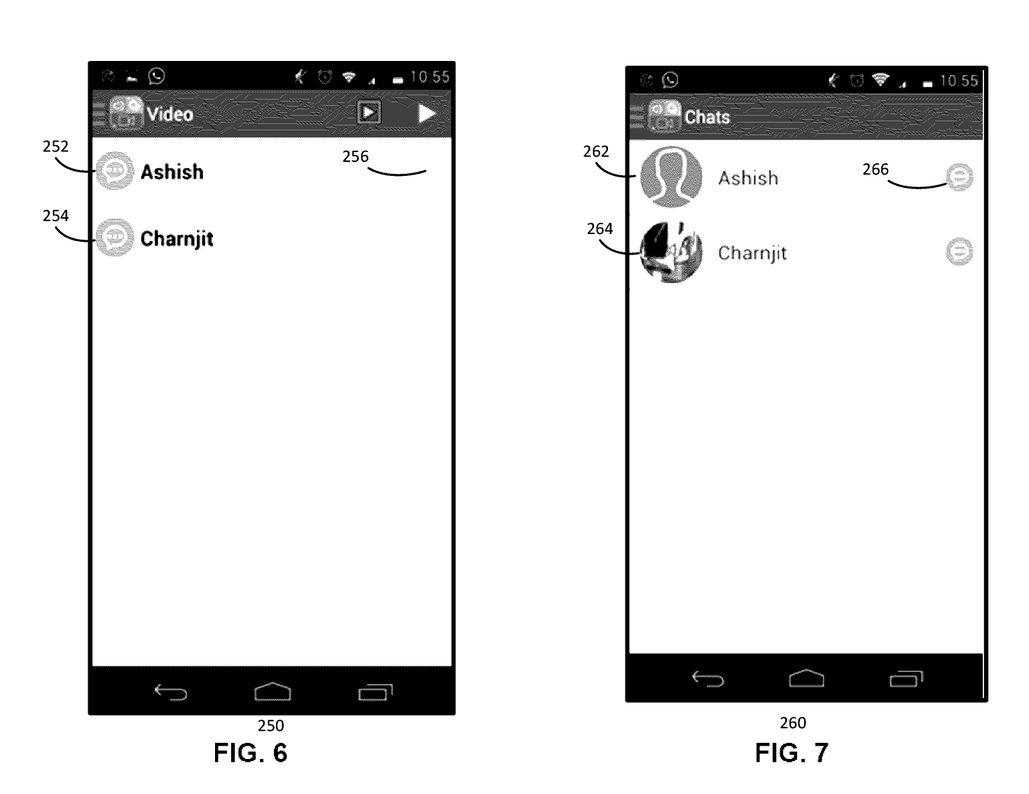

The user may initiate contact with other users in various ways such as by synchronizing a user's contacts with registered users of the platform, inviting known contacts to ‘Join’ a chat session, inviting a contact to view a broadcast, etc. As shown in FIG. 5, pressing the synchronize contacts button 237 may initiate a screen 240 and routine 242 whereby the application accesses a user contacts file on the user device, pulls phone numbers or other unique identifiers from the device-contacts, and compares (on the client or server side) the device-contact numbers with registered user numbers. For example, a user device may have a hundred contacts associated with a phone or other application. The contacts with phone numbers may be identified and those phone numbers used to search the platform server database including all registered users. A list of all corresponding contacts/users 252, 254 may then be presented on the display screen 250 of the user device such as shown in FIG. 6, allowing the device user to select any or all contacts that they want to associate with the platform application via select buttons 256. After the contacts are selected, they may show up in various command windows, e.g. as contacts 262, 264 in a chat launch screen 260 like shown in FIG. 7, a broadcast launch screen, etc. Chat initiate buttons 266 can be used to launch a chat session with the corresponding contact.

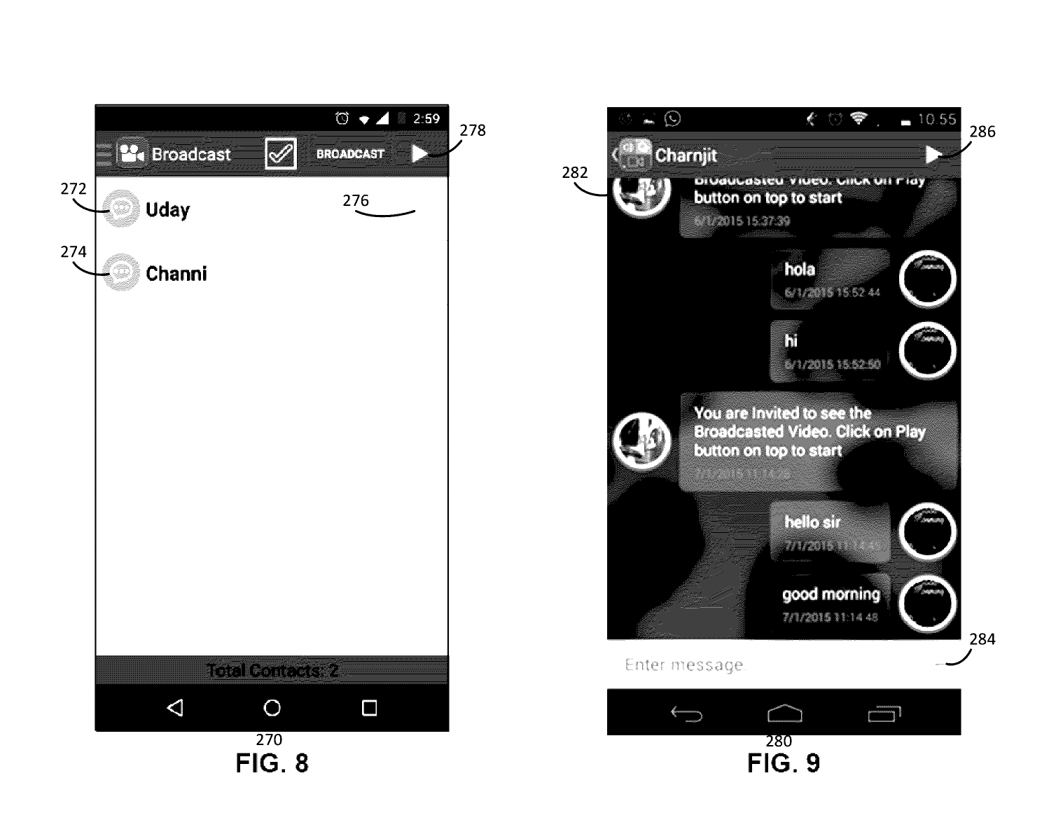

Once registered, users may interface with the platform and initiate broadcasts and communications with other users via the ‘Dashboard’ (e.g. FIG. 4). For example, in order to begin broadcasting video or other content the user may first select ‘Broadcast from the dashboard and then select ‘Broadcast’ in the top corner of the new page 270 shown in FIG. 8. In some examples, the contacts 272, 274 may be automatically included in a broadcast initiated from screen 270, or the user may select buttons 276 to designate the contacts to whom the broadcast will be directed to. In some examples, the screen 270 may initiate a broadcast based on activation of the ‘play’ arrow 278.

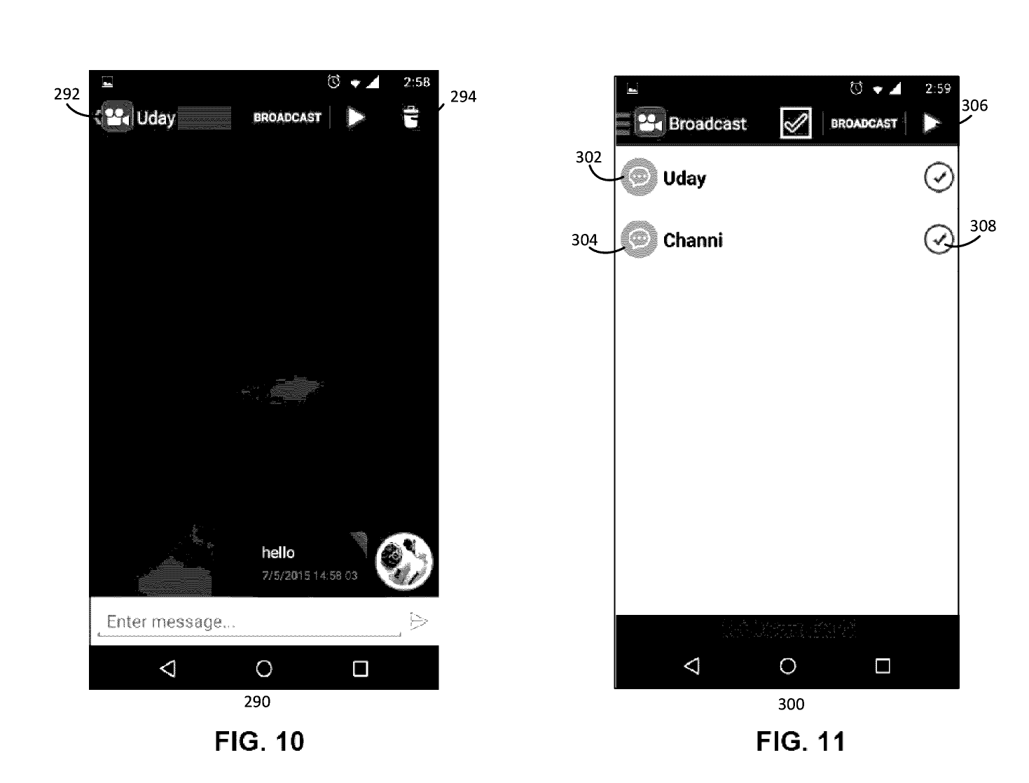

Alternatively, the user can initiate a broadcast while engaged in a chat session screen 280, with texts, photos or other content 282, message send button 284, etc., such as shown in FIG. 9, e.g. by pressing the ‘play’ arrow 286 in the top corner, or by pressing a ‘Broadcast’ button like shown in screen 290 of FIG. 10. If launched in a chat session, the platform server may push notifications of the broadcast to other user devices that are engaged in the chat, and/or other registered users depending on how the creating user designates the broadcast, e.g. public or private. In some examples, a chat or other screen like 290 may have a menu button(s) 292 and/or delete button 294 allow, for example, navigation and deletion of streaming sessions.

Upon receiving the command to begin a broadcast, the application may present the user with clarifying queries, as needed, such as via screen 300 in FIG. 11. For example, if a private broadcast is selected, a contacts screen may be presented allowing the user to designate which contacts 302, 304 should be notified of the broadcast, by selecting buttons 308, as shown in FIG. 11. In that example, the user has ‘checked’ both of the contacts to share the broadcast with, and can begin the streaming session by activating ‘play’ button 306. Upon selection of 306, the application may communicate with the streaming server to begin sending streamed data to the server. In some examples, this may include content such as video and/or audio data acquired by the portable user device, e.g. smartphone, tablet computer, etc., as well as identifying information associated with the streaming session such as a time stamp, a location, a title, a category, and/or a streaming mode. In some examples, the application may obtain certain identifying information from the user device or other applications running on the user device, such as time, date, location, etc. Other information may be input by the user using various interfaces such as those discussed herein, e.g. title, category, etc.

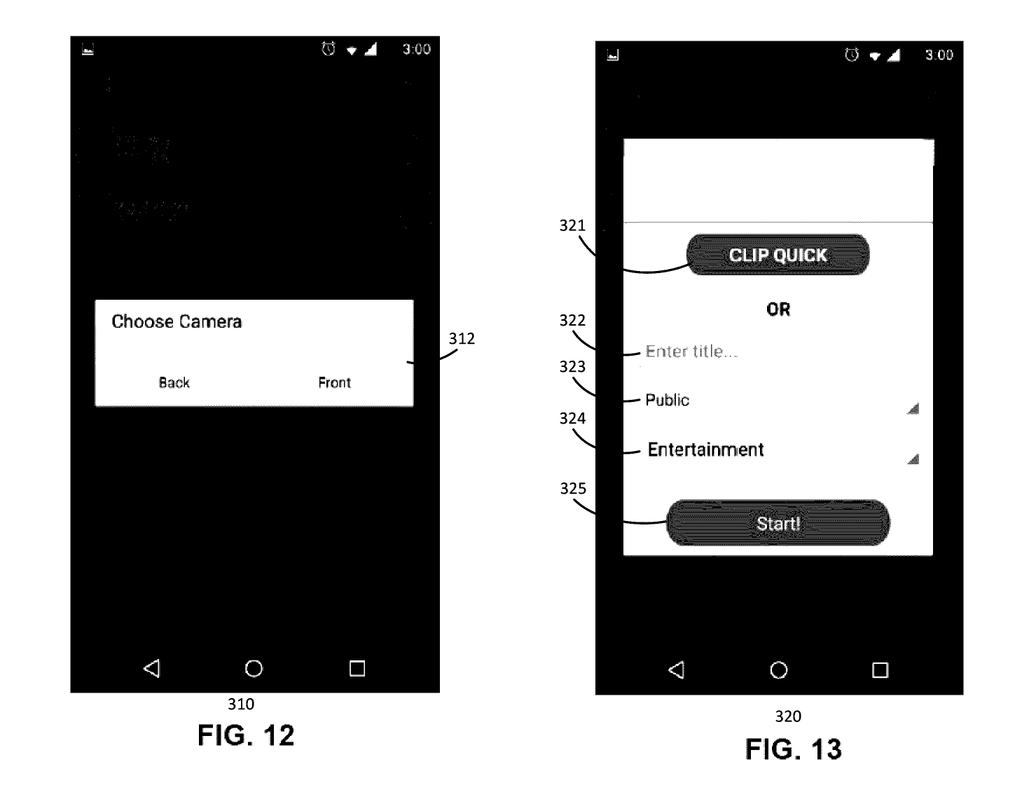

When initiating a video broadcast from a phone with multiple cameras, a window 312, such as shown in screen 310 of FIG. 12, may also appear that asks the user to choose which camera to use for the broadcast, front or back. In some embodiments, the application may also support camera switching while recording and/or streaming. For example, if a user is riding a roller coaster, they may want to continuously broadcast while switching between what they are seeing and what the expression on their own face looks like. Thus, a streaming session may be maintained even when switching between cameras.

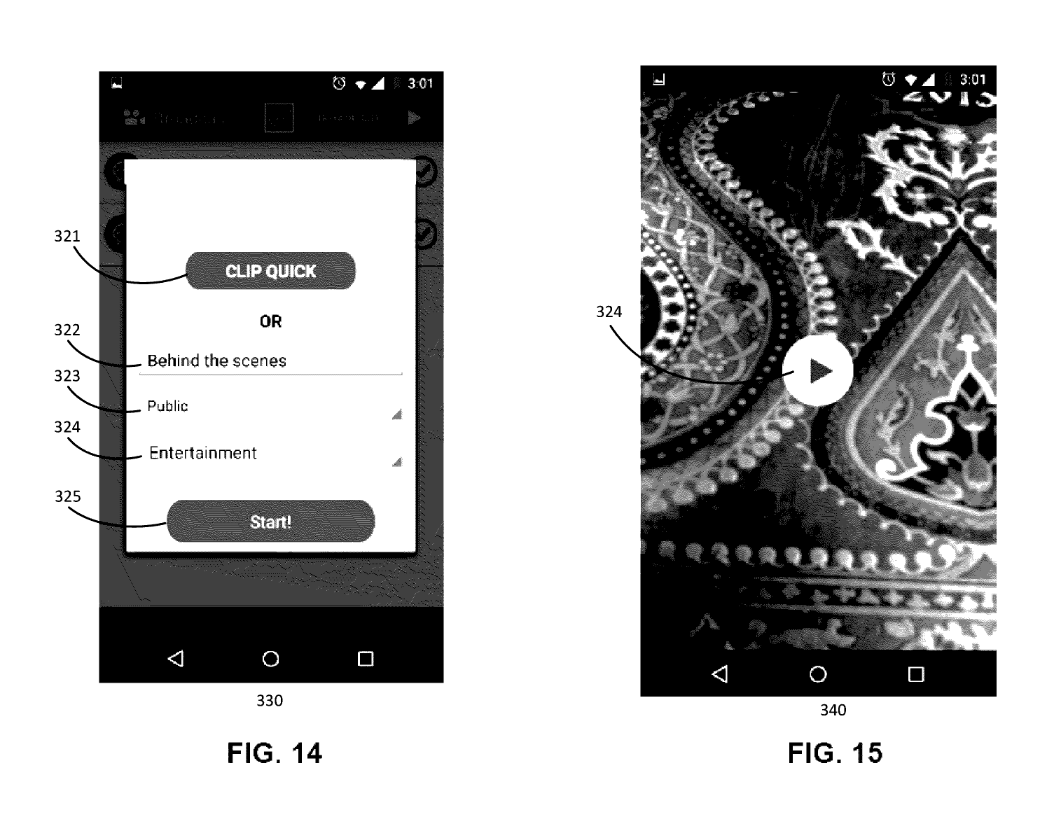

After the appropriate camera is selected another window may appear asking the user how they wish to broadcast, e.g. either by ‘Quick Clip’ button 321 or by ‘Title’ by filling in title block 322 as shown in screen 320 of FIG. 13. Selecting ‘Title’ allows the user to assign a searchable title 322, category 324 or other information to their broadcast as shown in FIGS. 13 and 14, e.g. for later viewing and/or search access.

However, users may skip this step and go directly to broadcasting by selecting ‘Quick Clip’ 321. This feature may take the user directly to the broadcast screen so they may begin recording and broadcasting immediately without entering any further information. In some examples, upon selecting Quick Clip 321, users may immediately begin broadcasting to all contacts and followers via the platform server. In some examples, the platform server may automatically assign certain identifying information to the Quick Clip, e.g. timestamp, location and/or user account information. The automatically assigned information may also be based on preset user parameters, and may be different based on different icons selected by the user to start the streaming session. For example, instead of one Quick Clip icon, the application may present the user with any number of configurable icons that designate parameters assigned to streaming sessions that are initiated via that icon. This can be used, for example, to automatically assign contact groups to share the streaming session with, categories and/or naming conventions for saving the streaming session, etc. The icons may also be layered in ways that assist the user in refining the desired parameters. For example, a first layer of icons may have options for categorizing a streaming session in various distinct ways, e.g. ‘Name,’ Location,“Activity,' etc. When the user selects one of such icons, such as ‘Name,’ another set of icons may be presented based on the selection, e.g. different icons for different family members that the user has set up, ‘Mom,’ Dad,”John,“Mary.' When the user selects one of these icons, it can start a streaming session with a name, category or other parameter automatically assigned based on one or more of the selections, e.g. ASSIGN CATEGORY ‘Name’; NAME FILE ‘JohnXX-XX-XXXX.’ In some examples, a ‘Quick Clip’ icon can be added to the main user interface screen, or other application, in order to allow immediate broadcast capability.

Once the user has completed the Quick Clip broadcast they may assign a title at that time and save the broadcast under ‘My Videos’. Assigning a title allows the broadcast to become available for public searches. If the user still does not wish to give a title the broadcast will only appear in proximity searches.

After selecting Quick Clip or Title, the user may be asked if they wish to make the broadcast ‘Public’ or ‘Private,’ e.g. via button 323. Of course, in some examples, the user may simply select ‘Public’ or ‘Private’ without having to select Quick Clip or Title depending on the specific type of interface screen that is presented and/or set by the user. If the user selects Public, they may be asked to choose a title 322, category 324 or other information for the broadcast, like in screen 330 of FIG. 14. If the user selects Private from screen 330 (or any other launch screen), a list of their contacts may appear from which they can choose whom to send the broadcast to (such as shown in FIG. 11).

After the user has selected Public or Private broadcast, they may then be taken to the ‘Play Button’ screen 340 like in FIG. 15 where they simply click the Play Button 324 in order to begin broadcasting. In some examples, this will involve exchanging information with the streaming server to ensure that the server is ready to receive and/or record the streaming data. In some examples, if there is a connection problem with the streaming server, the video or other content capture may be stored locally on the device until such time as the connection is reestablished. For Public broadcasts, all of the user's synchronized contacts and followers may receive notification from the streaming server that the user has begun a new broadcast. This can be done in myriad ways, such as sending messages via corresponding applications on other contacts' devices, instant messaging, email, etc.

The broadcast may be saved on the platform server 100 and may be accessible by the general public and/or registered users. These broadcasts can be searched by any identifying information, such as title, category or proximity to a searching user, and, in some cases, they cannot be edited or deleted.

For Private broadcasts, once the Play Button is clicked, the user may automatically begin broadcasting to their selected contacts. The broadcast may also be saved to the platform server so that selected contacts may view the content in real-time or at a later time. However, this content may only available to the selected contacts.

A second way in which users may initiate a private broadcast is by going directly to a contact's chat, as mentioned in FIGS. 9 and 10. Once the Play Button Is selected, the broadcast is streamed live to the members of the chat. The contacts may receive a pop-up notification (e.g. automated message) notifying them that they are being sent a broadcast and they can choose to view the content at that time. In the context of a streaming application, the pop up can include instructions for accessing the stream via the streaming server using the application itself. In case of IM or email notification, additional instructions may be included, e.g. for opening the appropriate application. Additionally, the broadcast may be saved under that contact's ‘My Videos’ and can be accessed at any point after the initial broadcast. Lastly, private broadcasts can be accessed through a search by the user (if they are a contact for whom the broadcast is accessible). It is also noted that the platform can support displaying a text chat area while simultaneously displaying a video stream.

In order to initiate the text/chat feature, users may simply select ‘Chat’ from the Dashboard . All registered user contacts will be available to select for chat. Once the desired contact is selected the chat window will open up. A gray circle indicates that the contact is ‘offline’ and a green circle indicates that the contact is ‘online’ Messages can still be sent to contacts who are offline and they will receive them once they are online. Attachments can also be sent via the chat feature.

For multi-person/group chat, the user again selects the Chat feature from the

Dashboard. Users can click the ‘+’ button at the top of the screen which will then take the user to their Contacts screen. From here the user may select the desired contacts they wish to include in the group chat and the selected contacts will be highlighted. The user then clicks ‘Next’ and may be prompted to enter a name for the group. Finally, the user clicks ‘Create’ in order to finish creating the group. The selected group members will receive a notification in the form of an invitation to join the group, which they can either accept or decline.

In some examples, broadcasting different types of content can be done simultaneously to the same or different audiences, e.g. using different, or combined, windows of an application. For example, users may have a portion of the application window displaying an instant messaging discussion (like in FIG. 9), while viewing a live broadcast with other viewers of the same broadcast in another portion of the application window (like in FIG. 15).

Still pictures can also be taken, or captured from a video stream, while broadcasting, texting or talking This may be performed, for example, using a ‘snapshot’ icon included on the broadcast or other screen that instructs the application, user device or server, to take a picture (if the camera is not being used) or isolate a frame from a video broadcast, and store the captured image. In some examples, the stored image may be automatically associated with the streaming session during which the image was captured. For example, a video broadcast may be linked to static images that a viewer can access while streaming the broadcast, the image(s) may be used as a reference image when user(s) are scrolling through available broadcasts, like in FIGS. 17-19, etc. In other examples, still images may be stored in association with a chat (or other broadcast) session, such that when, looking back on the chat session, a user can see the associated images.

In some examples, users may be able to send invitations to other users to specific types of content streaming. For example, a user that is viewing a video stream from another user may invite the broadcasting user to join a chat session, e.g. via a link that is displayed in the chat window 280 or video broadcast window 290, while viewing the broadcast. By way of further examples, a user may engage in video conferencing or a voice call while also instant messaging or broadcasting video (to the same or different audience).

In some examples, client-side applications may include features that allow a user to disable all, or some, notifications, e.g. via one or more icons, when broadcasting and/or viewing streaming content. The notifications that are disabled may include, for examples, incoming phone call, e-mail, appointment, or any other visual and/or audio, notifications presented on the user device. In some examples, a broadcast screen, like shown in FIGS. 14 and/or 15, may include an icon, or other option selector, that allows “interruption free” broadcasting. These may apply, for example, to calls received through other applications and/or services, such as the user's existing phone service or calls received through the applications' phone or other service, once it is available. This may be advantageous in many ways, such as (at the system level) preventing streaming processing from being interrupted, or (from a display perspective) preventing portions of the streaming screen from being blocked by such notifications, e.g. when the user has an incoming call. Since users may want to broadcast live and/or continuously, with no editing or retakes, this feature may be important for users broadcasting significant events, or a TV or radio show.

In some examples, the notification disable function may allow the user to select certain applications and/or types of notifications that are allowed, such as specifying ‘disable text message visual notification; allow text message vibration notification,’ etc. Applications may also be configured to change other applications' settings, such as sending a call immediately to voicemail, when an event notification would otherwise be generated. In some examples, a log of blocked notifications may be generated, and presented to the user after the broadcast is completed.

Broadcast screens may also include a ‘pause’ icon that allows the user to pause a stream while broadcasting, e.g. video, audio, etc. The server (e.g. 100) may be configured, for example, to present a static image to broadcast viewers while the broadcast is paused, and/or to pause storage of the broadcast file on the server. This allows a broadcaster to temporarily pause broadcasting and then resume broadcasting within the same broadcast. The server (e.g. 100) may be configured to notify viewers when broadcasting restarts, using similar techniques to the initial broadcast notification(s). This may also allow the broadcaster to keep the footage in one clip before it is posted in ‘All Videos’ or ‘My Videos.’ In some examples, once the broadcaster stops broadcasting, that video may be stored and accessed as an individual clip. Such features may be beneficial in various situations, such as when a broadcaster wants to broadcast different views of the same site or event, but wants to leave out the footage while they are walking from one point to the other (without having to go back and edit the video file).

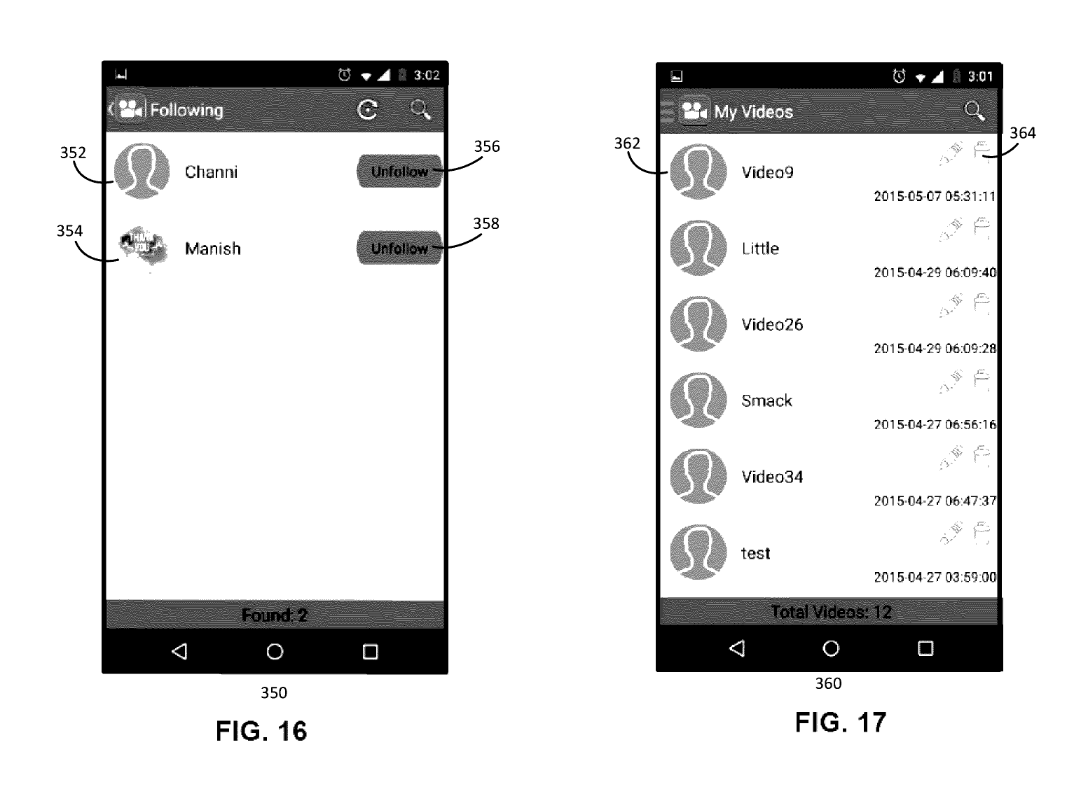

Public broadcasts and/or Quick Clips can also be sent to ‘Followers’. Followers are registered users for whom the broadcaster does not necessarily have phone numbers and to whom the broadcaster may not be able to send private messages. Followers can be categorized according to various user information, such as those previously discussed, including demographics, associated companies, etc. Followers may receive only public broadcasts from the users whom they choose to follow. Followers may be able to forward broadcasts to other users, post comments regarding broadcasts and they may also create forums regarding specific broadcasts in order to share their opinion and stimulate discussion among viewers, via the streaming service servers. A user can choose contacts to follow by using an application screen 350 like shown in FIG. 16, in which user icons 352, 354 may represent users that are being followed, or results of searching users based on shared information that the searcher is interested in. Buttons 356, 358 can be used to ‘Follow’ newly-identified users, or to ‘Unfollow’ already-established feeds. In some examples, a ‘Followers’ selection screen, or other interface, may further include controls for designating specific content type to follow, e.g. video, image, text, etc., as well as categories, or other identification data, that may be used to limit the alerts that are sent. Embodiments may also include functions allowing users to turn notifications on or off, e.g. for another user, content type, category, etc. Accordingly, users may be provided multiple ways to customize their alerts, e.g. to only receive notifications for the content they wish to follow for a particular broadcaster. This can prove beneficial in many ways, including preventing users from becoming inundated by notifications, focusing the types of alerts that the user receives, screening content that the user may find objectionable, etc.

Video conferencing may also be initiated using a ‘Call’ button from the Dashboard or other screen. Users may add, for example, up to four people (excluding themselves) on a video conference call. Users who are invited to join the call may in turn invite other contacts to the call as well.

Users can also access all of the broadcasts that they created, e.g. by selecting ‘My Videos’ and via a screen 360 like that shown in FIG. 17, which lists all of the videos 362 created by that device stored on the platform server and/or the user device. Edit and/or delete commands 364 may also be selectable by the user via screen 360.

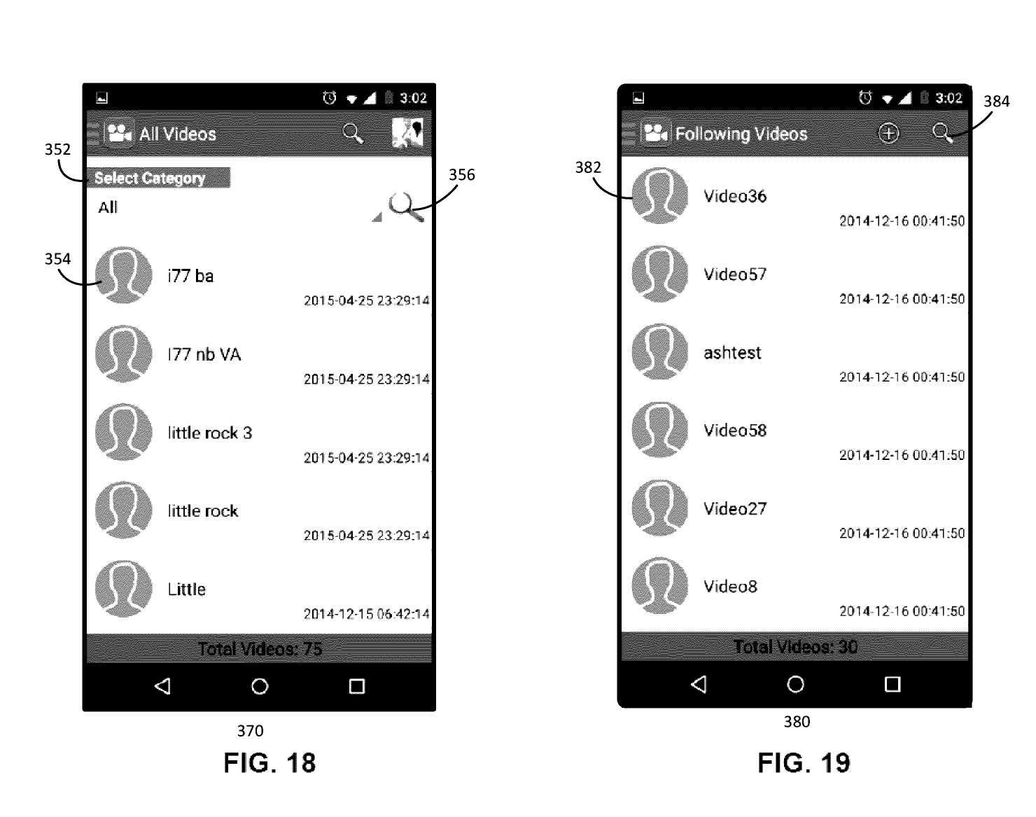

Likewise, the user can view lists of ‘All Videos’ that they have access to, like shown in screen 370 of FIG. 18, and/or the available broadcasts that they are ‘Following’, like shown in screen 380 of FIG. 19. These lists can be served by the platform server based on user permissions, preferences, etc. The broadcasts in these lists may include various indicia such as time stamps and user IDs, and may be searchable or organized based on any other available information including creator, title, time stamp, categories, proximity, locations, etc. In screen 370, the user can use search button 356 or a more general category selection button 352 to narrow the list of video files 354. Similar controls may also be implemented in screen 380, e.g. search button 384 and the like, to narrow the list of items 382 that the user is following.

In embodiments, the combination of the client-side applications and streaming server can allow broadcast and two way communication by video, voice and text. These can also broadcast in various combinations, e.g. music or other audio files while broadcasting video, texts while broadcasting or viewing video to others viewing that same video, etc. Additionally, the client-side application can receive information from the server indicating which contacts and/or followers are viewing the streaming session. Accordingly, the display on the user device can include indicia of specific contacts/followers that are connected to the streaming session.

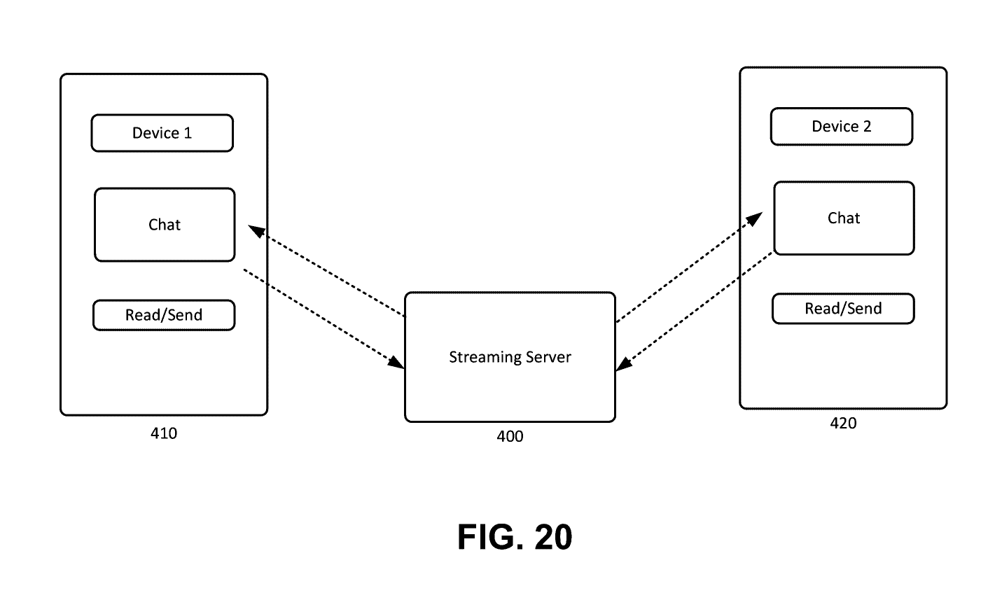

FIG. 20 is a schematic diagram showing synchronization relationships between a first device 410, a streaming service server 400 and second device 420, according to certain embodiments of the invention. In this case, the device 410 may be used to synchronize contacts, including scanning various files on device 410, another remote server, such as an enterprise email server, or crawling social media or other sites that the user is registered with, for any ‘contacts,’ which may be determined using various data file classification techniques. The identified contacts can be further reviewed for specifically formatted unique identifiers, such as phone numbers. Once gathered, the unique identifiers (or indicia thereof), may be transmitted to the server 400 and compared against the registered user accounts to identify any having matching unique identifiers. In some examples, the server 400 may send contact requests via common client-side application (or IM or email) to device 420 of any registered users that match the unique identifiers, or that the user of device 410 requests to add to their contacts.

Upon confirmation from user device 420, the server 400 may generate a message including embedded instructions that allow the application on device 410 to add the identified contact, after which the user of device 410 can chat and/or establish private broadcasts to the device 420. As mentioned previously, the foregoing method ensures a degree of privacy and verification that is not present in current systems that either allow unrecognized contact requests, or do not link a user with a unique and verifiable identifier.

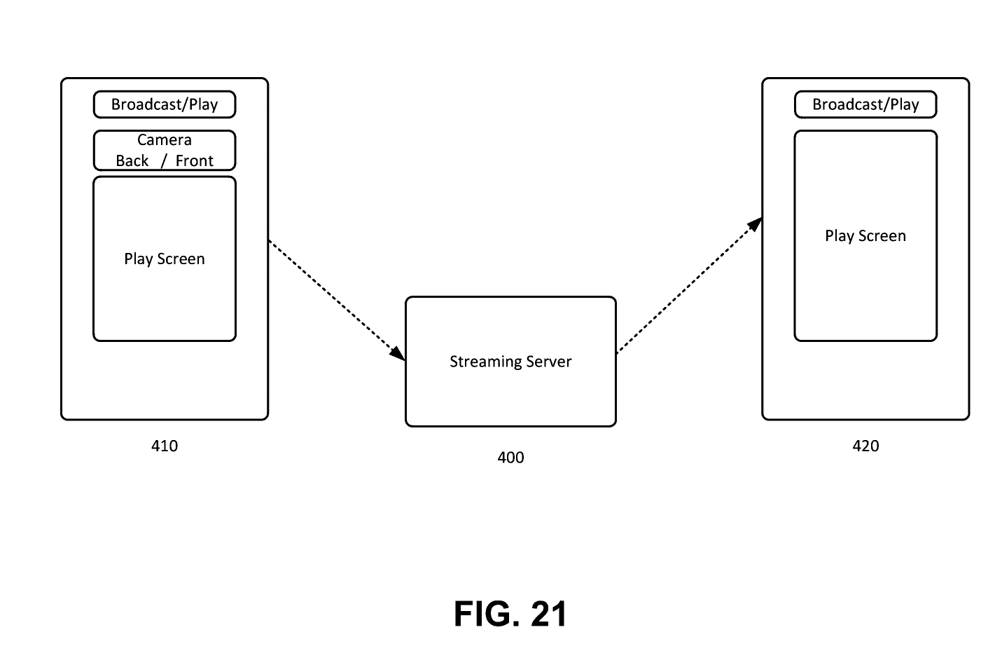

FIG. 21 is a schematic diagram generally showing streaming relationships between first device 410, streaming server 400 and second device 420, according to certain embodiments of the invention. As discussed previously, when initiating a streaming session on a first device, like device 410, the streaming service server 400 acts as an intermediary between the device 410 and any number of devices 420 that access the stream. The server 400 can store the streamed data, provide it in nearly real time to device(s) 420, and also make it available for searching and later viewing by devices 410, 420.

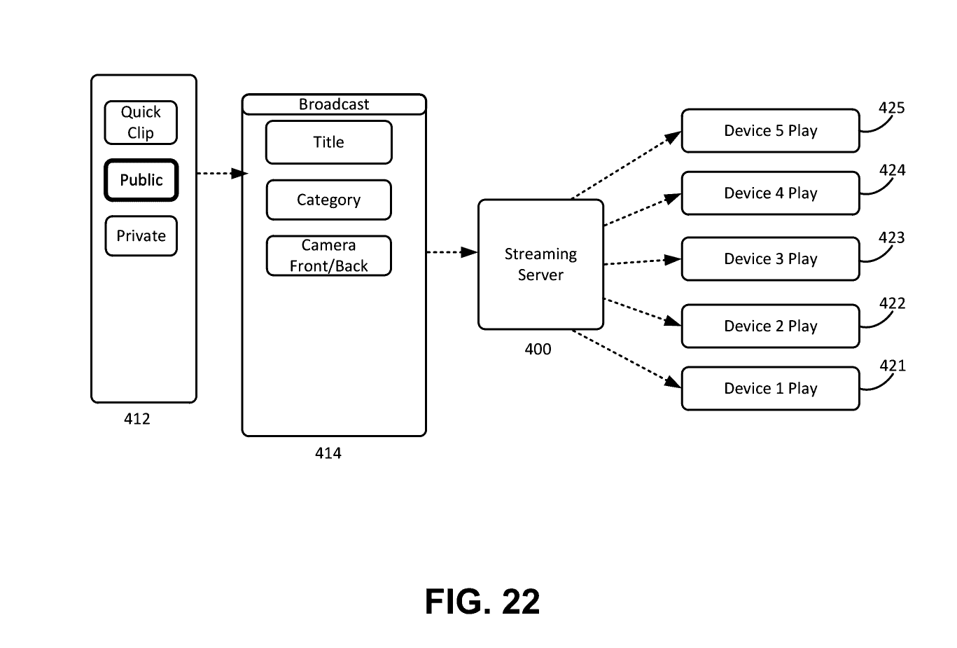

FIG. 22 is a schematic diagram depicting aspects of a public broadcast between a first device, streaming server 400 and various other devices, according to certain embodiments of the invention. In this case, a user viewing screen 412 selects a Public broadcast option, which causes transition to a second interface 414. The user device may send a first message to the streaming server 400 along with transitioning to the second interface 414, e.g. to prepare a cache or other storage allocation on the server to minimize lag once the streaming session is initiated. When viewing interface 414, a user can initiate a broadcast, with or without adding title, category or other identifying information. When the user initiates the broadcast, the streaming data is sent to the server 400 and stored according to any naming convention and categorization that have been preset or determined automatically. The server 400 also makes the streaming session available to all, or a subset of, the registered users. In this regard, various devices 421-425 including similar streaming applications may access the streaming session via server 400 in near real time, or at a later time. In some examples, registered users who are contacts and/or followers of the streaming session creator may be sent alerts that the streaming session is available. In other cases, the streaming session may be discovered, e.g. using a search function of the application software.

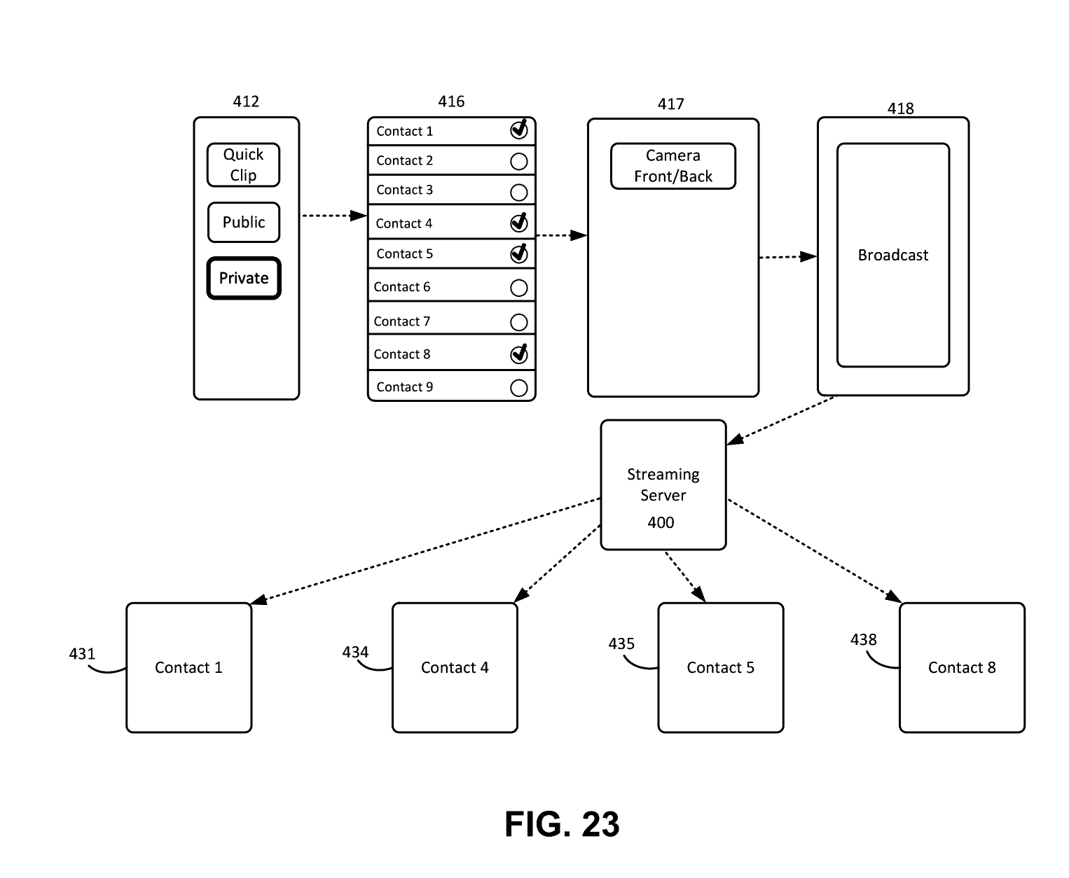

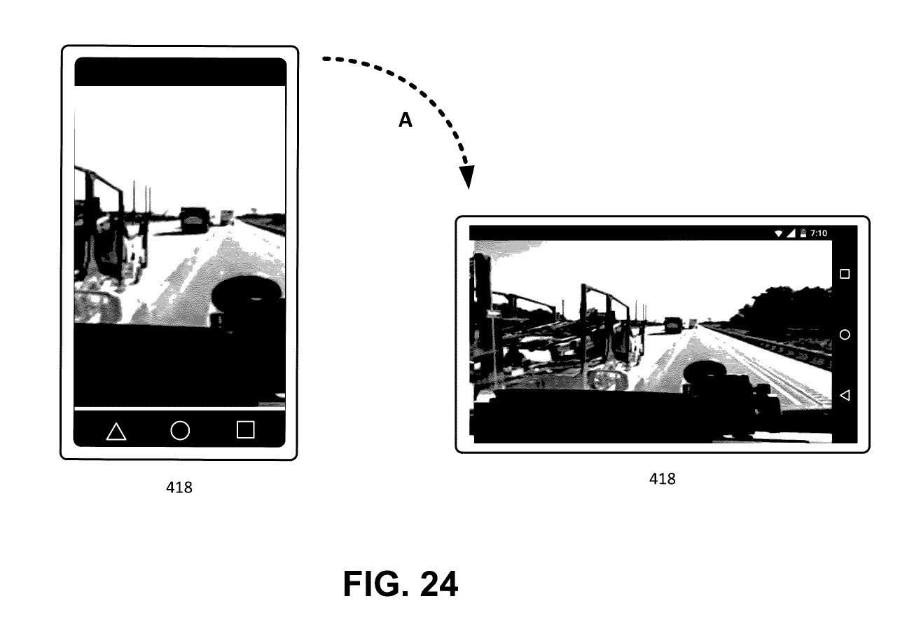

FIG. 23 is a schematic diagram depicting aspects of a private broadcast between a first device, a streaming server and various specified contacts, according to certain embodiments of the invention. In this case, a user viewing screen 412 selects a Private broadcast option, which causes transition to a second interface 416 that allows the user to select contacts that the streaming session will be shared with. In the example shown in FIG. 23, the user selects contacts 1, 4, 5 and 8 to share the broadcast with. It should be noted that, in some cases, a user may also be able to share a broadcast with a predetermined group of contacts and/or follower(s). After selecting the contacts in 416, a third screen 417 may be presented including a front/back camera select icon. After selecting the desired camera, another screen 418 may be presented including a view of the broadcast. As mentioned previously, during streaming, a camera select button may also be included that allow transitioning between different cameras during a streaming session. Embodiments may also support capturing videos from the front or back camera in ‘Portrait’ or ‘Landscape’ modes. In some examples, the camera may be rotated while broadcasting and the orientation of the video modified accordingly without interruption, such as shown in FIG. 24. This may be done, for example, by configuring the streaming server to automatically detect changes in the orientation of the video images, and to modify the broadcast accordingly. Additional link buttons may also be included that allow various multimedia content to be included in the streaming session, e.g. music stored on, or otherwise accessible by, the user device, other application data, documents, phone calls, texts, etc.

The user device may send a first message to the streaming server 400 along with transitioning to any of the various interfaces, e.g. to prepare a cache or other storage allocation on the server to minimize lag once the streaming session is initiated. When viewing interface 417, a user can initiate a broadcast, with or without adding title, category or other identifying information. However, in some examples, a user may be presented with a screen like 414 before, during or after the streaming session. When the user initiates the broadcast, the streaming data is sent to the server 400 and stored according to any naming convention and categorization that have been preset or determined automatically. The server 400 also makes the streaming session available to the selected contacts, in this case contact 1 via device 431, contact 4 via device 434, contact 5 via device 435, and contact 8 via device 438. In this regard, devices 431, 434, 435 and 438 including similar streaming applications may access the streaming session via server 400 in near real time, or at a later time. In some examples, the server 400 alerts the selected contacts and/or followers of the Private broadcast via alerts sent to similar applications and/or IM, email or other messaging techniques. It should be appreciated that, depending on different features supported by various applications and operating systems, notifications may still be received by a user even if the specific streaming application is not ‘open’ at the initial notification generation time.

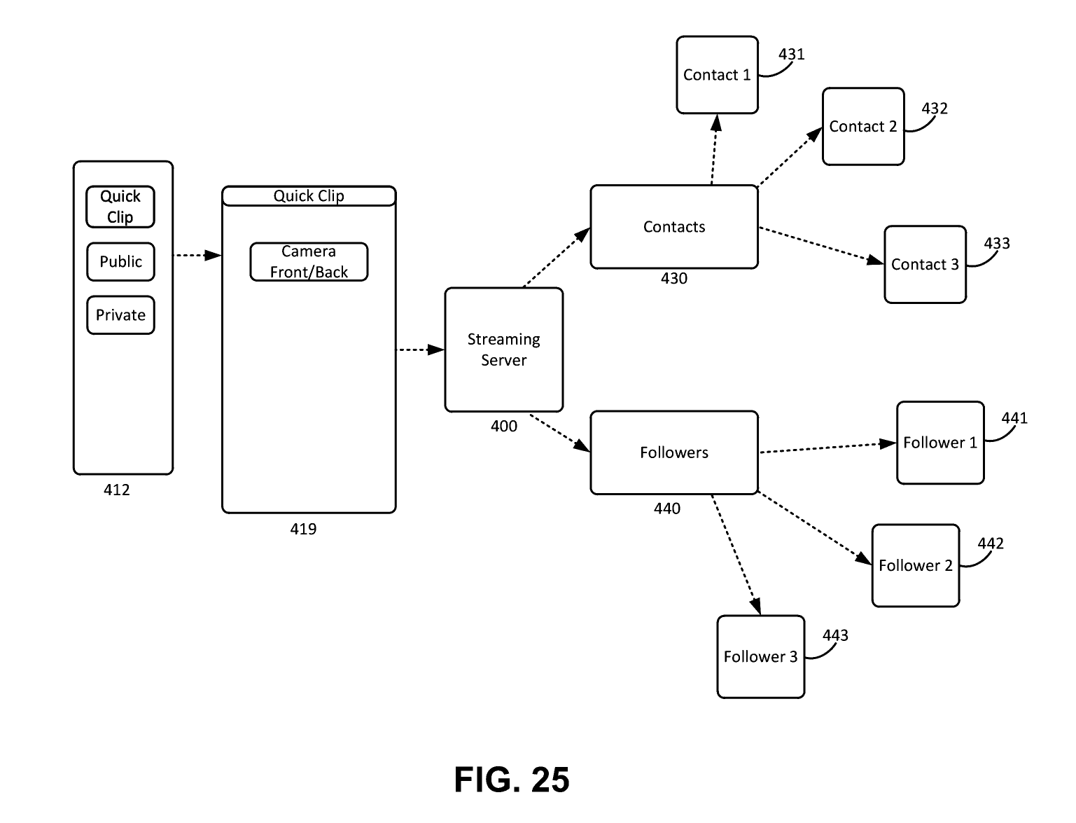

FIG. 25 is a schematic diagram depicting aspects of a ‘Quick Clip’ broadcast between a first device, a streaming server 400 and various contacts 431-433 and followers 441-443, according to certain embodiments of the invention. This type of broadcast may be configured to bypass or omit certain functions that are presented to the user as part of another broadcast mode, such as the Private broadcast described in the context of FIG. 23. For example, upon selecting the ‘Quick Clip’ icon from screen 412, the user application may initiate a video streaming session with the server based on predetermined parameters, or a limited set of parameters, such as a front/back camera select option shown in 419. The server may automatically assign an identifier for the stream and begin storing and/or broadcasting the video. Automatic identification may be based, for example, on timestamp, location, and/or phone number information. In some examples, a plurality of different ‘Quick Clip’ or similar icons may be presented with different preset parameters used to acquire, name, store and/or broadcast streams. For example, a user may preconfigure a plurality of icons for each of their children, so that when they select a certain ‘Quick Clip’ icon it automatically categorizes and/or names the stream with the corresponding child. Myriad other options are possible such as predesignated streaming groups with associated contacts, e.g. ‘Grandparents,’ Soccer Fans,' Music Fans,' etc.

In the example shown in FIG. 25, the ‘Quick Clip’ icon is configured to automatically alert a plurality of the users' contacts 431-433 as well as the user's followers 441-443, via contact list 430 and follower list 440. In some examples, the server 440 may store such broadcasts in a way that prevents the user from editing and/or deleting the saved stream from the server. In some examples, different hierarchies for editing and/or deleting may be assigned based on the type of stream, and may require some edit/delete requests to be approved by the service provider.

In some examples, the user may be presented with an option to assign title, category or other identifiers (like shown in FIG. 13) after the stream is stopped, or at some other time (e.g. if the user selects the saved video from their ‘My Videos’ menu.

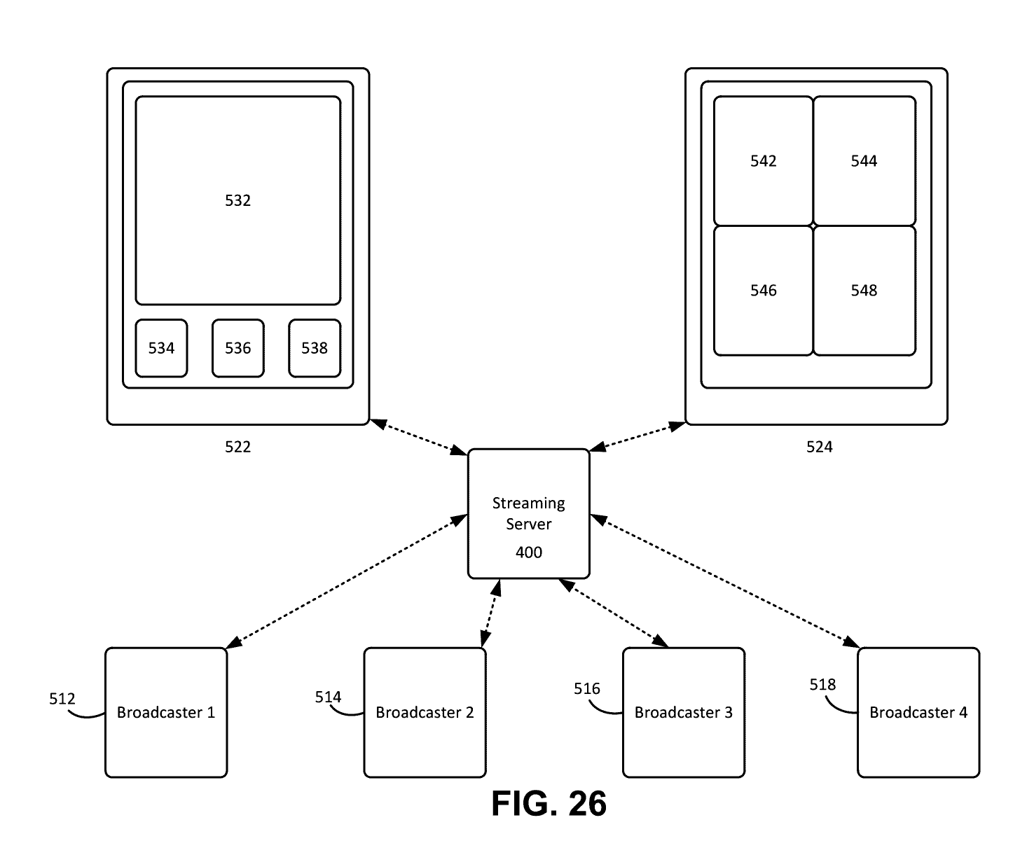

In some examples, two or more broadcasts can be coordinated into a single broadcast, e.g. that shows in a single screen or a view that rotates broadcasters. For example, as shown in FIG. 26, a plurality of broadcasters 512-518 may be streaming content to streaming server 400.

The streaming server 400 may automatically associate these broadcasts, e.g. by location, by assigned category, by user groups, by user ‘event registration’ provided by the streaming service or other social media sites accessible by the streaming service, etc. In some examples, one or more of broadcasters 512-518 may initiate the association by sending a request to streaming server 400. This may be facilitated in many different ways, such as one of the broadcasters (e.g.

512) detecting or linking one of the other broadcasters (e.g. 514-518), a broadcaster sending invitations to other user(s) to join a broadcast, a broadcast viewer clicking a ‘join broadcast’ icon presented during a broadcast, etc.

The streaming server 400 may broadcast associated streams as a combined (or viewer-configurable) broadcast to various users, such as user devices 522 and 524. The combined broadcast can be configured in various ways, such as presenting a selected broadcast 532 (which may be provided by broadcaster 512), and selectable icons 534-538 (which may be associated with broadcasts from broadcasters 514-518). The streaming server 400 may automatically cycle through the different broadcasts in the broadcast provided to user device 522 (and/or other viewers), or may allow the user to select between associated broadcasts. The streaming server 400 may also present a combined broadcast with simultaneous display of a plurality of individual broadcasts, e.g. as shown on user device 524 with streaming windows 542-548, which may be derived from broadcasters 512-518, respectively. In some examples, the content of windows 542-548 may be selected from a larger number of associated broadcasts, e.g. from dozens or hundreds of broadcasters at a particular event. The application presented on either of user derives 522 or 524 may also allow a viewer to rate a specific broadcast, which may be used, for example, by the streaming server 400 (or user device) to weight the priority for individual broadcasts in a combined broadcast. For example, the streaming server 400 may determine which broadcasts are rated as best by viewers and present those more frequently (e.g. among display windows 542-548) or uniquely (e.g. in display window 532).

Combined broadcasts may be stored in various ways. For example, each of the individual broadcasts may be stored in association with the originating broadcaster (such as previously described), and a file that associates the broadcasts may be separately saved. A user may then select the associating file (e.g. linked to an icon in the ‘All Videos’ screen 370) at a later time, and be presented with the combined broadcast from the separately stored broadcast files. The streaming server 400 may also store records that associate specific broadcast streams that a user chooses to watch during specific times, e.g. so that the user can easily go back and view the parts, individuals, and/or perspectives of an event that they focused in on during a combined broadcast, etc.

A further use example may involve a group of people attending a concert or other event, and one of the users creates a combined broadcast by selecting other users that are at the event or in the area. The combined broadcast may be viewed and/or stored by the streaming server under its own name, assigned by the creating user. Such features may also be used with videos that have already been created. For example, if a user wants to create a collage of their own videos, they may select from among existing accessible videos, and select a ‘Combine’ icon, or the like, e.g. from video select screens in FIGS. 17-19, to create a combined broadcast that may be stored under a new file name.

Streaming sessions discussed herein can also be linked to various social media accounts, and/or registered as a ‘TV channel’ name (similar to registering as a business) and broadcast videos through that ‘channel.’ In addition to a TV channel, users can also create a ‘radio channel’ if they wish to only broadcast voice/sound.

In embodiments, the streaming server may be configured to selectively provide public content to other streaming services for broadcast via other websites. Such distribution may be based on, for example, separate licensing or other arrangements with such services, whereby certain content (e.g. content that is viewed a certain number of times) becomes available to the other services for access by users that are not registered with the originating streaming service.

In some examples, systems and methods described herein may also include functionality that adds advertisements, such as commercials, before or after a streaming session, or adds banner advertisements or the like to public streaming sessions. This may be done, for example, via the streaming server and may pull advertising content from various third-party sources, and included in streaming broadcasts. In some examples, users may be able to pay an additional fee to remove such advertisements from the content that they are broadcasting or receiving.

In some embodiments, the streaming service provider may also limit users from broadcasting content from which they receive revenue, e.g. by scanning streaming data for embedded advertisements, etc. This can employ techniques such as scanning for static portions of image or video data, Thus, the service provider can be equipped with means for reserving the rights to revenue streams generated by videos or advertisements on videos. In some examples, streaming sessions may be monitored for content that is prohibited by the service provider's terms of use, or the like, and accounts may be automatically suspended based at least in part on such scans.

In embodiments, the client application may also be configured to upload pre-recorded or produced content (such as videos, audio files, etc.) to the streaming server. This may be implemented, for example, via icon(s) that access files stored on the user device, or that are otherwise accessible, and transferring those files to the streaming server where they may be stored in association with the user account. Such files may be accessed by other users in similar manner to the streaming session examples discussed above.

In addition, embodiments of the present invention further include computer-readable storage media that include program instructions for performing various computer-implemented operations as described herein. The computer readable medium is any data storage device that can store data which can thereafter be read by an electronic system. The media may also include, alone or in combination with the program instructions, data files, data structures, tables, and the like. The media and program instructions may be those specially designed and constructed for the purposes of the present subject matter, or they may be of the kind available to those having skill in the computer software arts. Examples of computer-readable storage media include magnetic media such as flash drives, hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

The computer readable medium can also be distributed over a network coupled to electronic systems so that the computer readable code is stored and executed in a distributed fashion.

The description given above is merely illustrative and is not meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for selectively providing streaming services in a network environment, comprising:
a database including a plurality of registered user accounts for a first service provider, each user account having a unique identifier assigned to a user of the account by a second service provider; and
a network server configured to:
establish a first network connection with a first user device associated with a first user account;
receive instructions to begin a first streaming session;
send a notification of the first streaming session to at least one other user account;
receive streaming data of the first streaming session from the first user device;
store at least part of the streaming data in association with the first user account;
receive a confirmation from the at least one other user indicating acceptance of the streaming session;
establish a second network connection with the at least one other user based on said confirmation; and
deliver at least part of the streamed data to the at least one other user via the second network connection, wherein the instructions to begin the first streaming session include a streaming mode selection that identifies the first streaming session as a public broadcast or a private broadcast, and wherein the server is further configured to make public broadcast available to all of the registered user accounts, and to make private broadcasts available to a select subset of the registered user accounts.

2. The system of claim 1, wherein the unique identifier is a phone number, and the server is further configured to automatically determine the validity of the phone number as part of registering a user account.

3. The system of claim 1, wherein the first service provider is a video streaming service, the second service provider is a phone company, and the unique identifier is a phone number.

4. The system of claim 1, wherein the server is further configured to:
receive contact information from the first user device;
compare the contact information to the unique identifiers of at least some of the user accounts stored in the database; and
generate computer instructions that allow the first user device to show registered user accounts having unique identifiers that match the contact information.

5. The system of claim 1, wherein sending the notification of the streaming session to at least one other user includes sending notifications to contacts associated with the first user account and followers associated with the first user account.

6. The system of claim 1, wherein the server is further configured to receive contact selection information from the first user device, the contact selection information identifying registered user accounts that a private broadcast is to be shared with.

7. The system of claim 1, wherein the server is further configured to receive identifying information from the first user device, the identifying information associated with the first streaming session and including at least three of a time stamp, a location, a title, a category, and a streaming mode.

8. The system of claim 7, wherein at least some of the identifying information is received from the first user device after receiving at least some of the streaming data of the first streaming session from the first user device.

9. The system of claim 1, wherein the server is configured to support chat session between registered users, and to begin the first streaming session between registered users participating in a chat session.

10. A personal computing device configured to provide streaming services, comprising:
a network communication transceiver;
a camera;
a processor; and
a memory including computer-executable instructions that configure the processor to:
exchange registration information with a first service provider in order to obtain a registered user account, the registration information including a unique identifier assigned to the personal computing device by a second service provider;
scan at least part of the memory for contact information;
extract unique identifiers from contact information found by the scan;
send indicia of the unique identifiers to the first service provider;
receive conformation from the first service provider that one or more contacts associated with the unique identifiers are registered users of the first service provider;
set the one or more contacts associated with the unique identifiers as streaming contacts;
establish a first network connection with a streaming server associated with the first service provider;
send instructions to the streaming server to begin a first streaming session;
capture image data via the camera; and
send streaming data of the first streaming session to the streaming server, the streaming data including the captured image data, wherein the instructions to begin the first streaming session include a streaming mode selection that identifies the first streaming session as a public broadcast or a private broadcast, and wherein instructions to begin private broadcasts include identification of the one or more contacts to whom the private broadcast is made available.

11. The device of claim 10, wherein the unique identifier is a phone number assigned to the device.

12. The device of claim 10, wherein the camera includes at least two cameras that can be alternated between while sending the streaming data.

13. The device of claim 10, wherein the computer-executable instructions further configure the processor to receive identifying information associated with the first streaming session and including at least three of a time stamp, a location, a title, a category, and a streaming mode.

14. The device of claim 10, wherein the device is configured to support chat session between registered users, and to begin the first streaming session between registered users participating in a chat session.

15. A streaming application comprising:
computer instructions configured to exchange information between hardware onboard a personal computing device and a remote server associated with a first service provider; and
a graphical user interface that is presented on a display of the personal computing device, the graphical user interface including a plurality of different interactive screens including:
a registration interface configured to receive commands for registering the personal computing device with the first service provider using a unique identifier assigned to the personal computing device by a second service provider;
a contact synchronization interface configured to identify potential contacts for the streaming application based at least in part on scanning for contact information, extracting unique identifiers from contact information found by the scan, sending indicia of the unique identifiers to the first service provider, and receiving conformation from the first service provider that one or more contacts associated with the unique identifiers are registered users of the first service provider;
a streaming initiation interface configured to allow a user of the personal computing device to initiate a first streaming session from among a plurality of streaming modes, the plurality of streaming modes including at least a private mode and a public mode;
a private session interface, initiated by selection of the private mode and configured to allow a user of the personal computing device to identify certain registered users of the first service provider that the first streaming session will be shared with; and a public session interface, initiated by selection of the public mode and configured to share the first streaming session with at least some registered users of the first service provider that are not specifically authorized by the user.

16. The application of claim 15, wherein the public mode shares the first streaming session with all registered users of the first service provider.

17. The application of claim 15, further comprising a chat interface configured to present chat sessions between registered users of the first service provider, and to begin the first streaming session between registered users while participating in a chat session.

18. The application of claim 15, further comprising instructions for:
establishing a first network connection with a streaming server associated with the first service provider;
sending instructions to the streaming server to begin the first streaming session;
capturing image data via a camera; and
sending streaming data of the first streaming session to the streaming server, the streaming data including the captured image data.

19. The application of claim 15, wherein the unique identifier is a phone number assigned to the personal computing device.

20. The application of claim 15, further comprising instructions for receive identifying information associated with the first streaming session and including at least three of a time stamp, a location, a title, a category, and a streaming mode.
